(19) United States
(12) Patent Application Publication
(10) Pub. No.: US 2007/0073910 A1
(43) Pub. Date: Mar. 29, 2007

(54) Portable composite device

(75) Inventors: Jangee Chen, Taipei (TW); Shi En Wang, Taipei (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/340,971

(22) Filed: Jan. 27, 2006

(30) Foreign Application Priority Data
Sep. 28, 2005 (TW) TW94133733

(51) Int. Cl. G06F 3/00

(52) U.S. Cl. 710/8

(57) ABSTRACT

A portable composite device comprises a main body having an opening, electrically connected to a host, a digital TV receiving module disposed in the main body, and a memory card access module disposed in the main body. A memory card inserted into the opening accesses the memory card access module.

### BACKGROUND

The invention relates to a portable composite device, and in particular to a portable composite device serving as a digital TV receiver and memory card reader.

TV programs can be displayed on various hosts, such as desktops, laptops, personal digital assistants, and mobile phones, via a digital TV receiver. A host can have various peripheral devices with different functions. For example, to watch TV and transport data, two peripheral devices are needed, such as is a digital TV receiver and a card reader, an inconvenient method. Further, portable devices often provide only limited USB or PCMCIA interfaces, limiting the number of peripheral devices used at one time.

### SUMMARY

An embodiment of a portable composite device of the invention comprises a main body having an opening, electrically connected to a host, a digital TV receiving module and memory card access module both disposed in the main body. A memory card is received in the opening.

The digital TV receiving module and the memory card access module, when detected by the host, serve as peripheral devices simultaneously.

Either the digital TV receiving module or the memory card access module can further be detected by the host to function alone. The digital TV receiving module or the memory card access module can be manually selected.

The main body has a universal serial bus connector electrically connected to the host.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of a portable composite device of the invention; and

FIG. 2 is a perspective view of another embodiment of a portable composite device of the invention.

### DETAILED DESCRIPTION

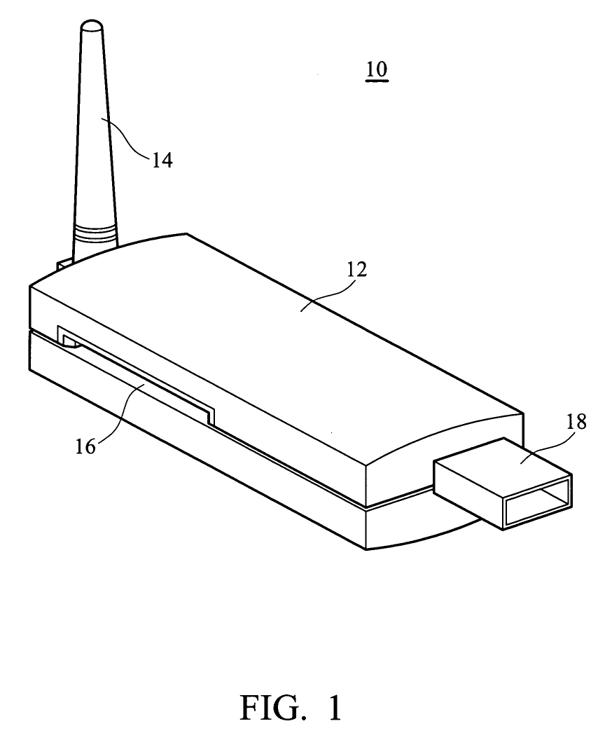

Referring to FIG. 1, a portable composite device 10 comprises a digital TV receiving module and a memory card access module. The portable composite device 10 comprises a main body 12, an antenna 14, an opening 16 and USB connector 18. The digital TV receiving module and the memory card access module are disposed in the main body 12. The antenna 14 is a part of the digital TV receiving module. A memory card can be received in the opening 16. The portable composite device 10 is electrically connected to a host (not shown), such as a laptop, via the USB connector 18.

The portable composite device 10 can be two types. When the portable composite device 10 is connected to the host, the digital TV receiving module and the memory card access module are detected by the host simultaneously to serve as peripheral devices, or only one of the digital TV receiving module and the memory card access module is detected.

In the first type, the digital TV receiving module driver can be saved in a memory card. When the portable composite device 10 is connected the host, the host detects the peripheral devices automatically. As the memory card access module is usually supported by operating system, the memory card access module is detected in advance, and the driver of the digital TV receiving module is installed, whereby the digital TV receiving module can be detected as a peripheral device. Digital TV signals are processed by a modulator-demodulator to obtain MPEG2 digital files, which can be saved in a memory card via appropriate application programs.

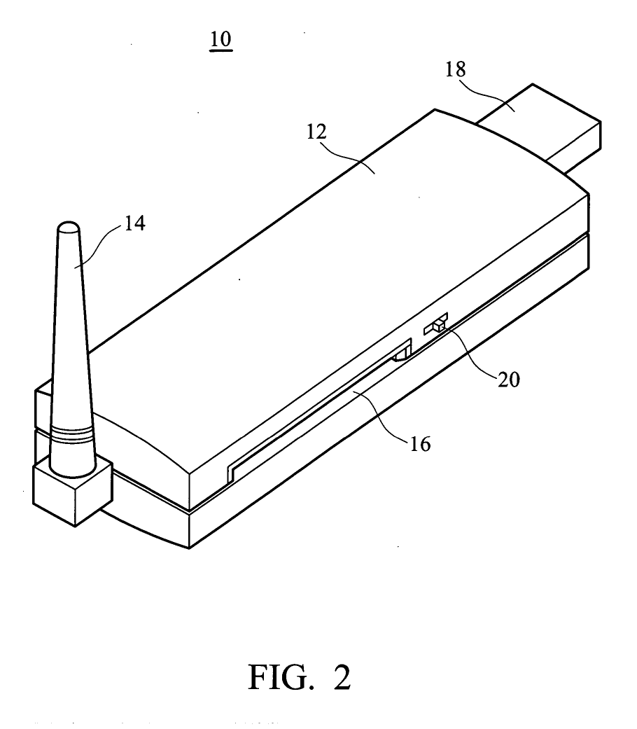

In the second type, as shown in FIG. 2, a switch 20 is disposed on the main body 12 to manually select the module to be detected. The switch 20 can be pushed right or left to select the digital TV receiving module or memory card access module. When the digital TV receiving module is selected, the portable composite device 10 serves as a digital TV receiver. When the memory card access module is selected, the portable composite device 10 serves as a card reader.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable composite device, comprising:
a main body having an opening, electrically connected to a host;
a digital TV receiving module disposed in the main body; and
a memory card access module disposed in the main body, wherein a memory card inserted into the opening accesses the memory card access module.

2. The portable composite device as claimed in claim 1, wherein the digital TV receiving module and the memory card access module are detected by the host to serve simultaneously as peripheral devices.

3. The portable composite device as claimed in claim 1, wherein either the digital TV receiving module or the memory card access module is detected by the host to serve as a peripheral device.

4. The portable composite device as claimed in claim 3, wherein the digital TV receiving module or the memory card access module is manually selected as the peripheral device.

5. The portable composite device as claimed in claim 1, wherein the main body has a universal serial bus connector providing electrical connection to the host.
